(19) United States
(12) Patent Application Publication
(10) Pub. No.: US 2008/0194295 A1
(43) Pub. Date: Aug. 14, 2008

(54) Method of providing universal platform for application program of communication terminals

(75) Inventor: Khein-Seng Pua, Hsin-Chu Hsien (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsin-Chu Hsien (TW)

(21) Appl. No.: 11/704,988

(22) Filed: Feb. 12, 2007

(51) Int. Cl. H04M 1/00

(52) U.S. Cl. 455/558

(57) ABSTRACT

A method of providing a universal platform for an application program for use in a communication terminal is disclosed. Meanwhile, the method of providing a universal platform for an application program of communication terminals, includes the steps of: a) storing a virtual machine and an application program in a combo card; b) providing the combo card to each of the communication terminals; c) loading the virtual machine from the combo card; and d) executing the virtual machine to form the universal platform such that the application program can be performed in the communication terminals regardless of different operating systems of the communication terminals.

### FIELD OF THE INVENTION

The present invention relates to a method of providing a universal platform for an application program, and more particularly, to a method of providing a universal platform for an application program for use in a communication terminal, i.e., a mobile phone.

### BACKGROUND OF THE INVENTION

Nowadays mobile equipment systems generally use special smart card applications. Meanwhile, mobile communication network operators and mobile terminal manufacturers make available to their customers an increasing number of services and applications. However, many known wireless mobile communication devices (“mobile devices”) support different types of communication network connections and data exchange with different information sources or destination systems. Meanwhile, modern mobile phones are often enabled for both data and voice communications and typically exchange both public and private information with remote communication terminal, including web servers on the Internet and data servers associated with a user's employer.

In practice, a lot of application programs are developed for mobile devices. As we known, data for mobile devices is stored on a small physically implemented silicon chip of SIM card connected with the terminal equipment. At least storing means are arranged on the chip for storing the above-mentioned data and for using it in the terminal equipment as well as a possible micro controller functioning as the processor unit. In some environments the processor functionality may also be arranged in the terminal equipment module properly.

For SIM cards of the known kind there is a standard connection in the mobile terminal equipment including connecting pins for connecting it electrically to the terminal equipment. The micro controller possibly placed on the SIM card is used to carry out the SIM application, which has several different manufacturers, as is known. In the state of the art, network operators or other such providers of subscriber connection services give these manufacturers their own instructions and settings, and the SIM applications will be in accordance with these in the end. The application includes, among other things, the micro controller's instruction set and file references for reading, interpreting and updating the network, terminal equipment and subscriber data arranged in the storing devices, as well as execution of authentication and encryption algorithms.

However, the use of mobile telecommunications and its importance is rapidly increasing in both the private and business sectors. In an effort to attract new customers and to keep existing customers, network operators try to offer a variety of service options. Ideally, network operators would like to be able to introduce new services quickly and to have these services unique to their own networks.

Currently, network operators offer services such as voicemail, address books and up to date information such as stock market quotations. A user selects which services he wants when he chooses his network operator and phone. Other services may be added by contacting his network operator. Services such as stock market quotations are provided by a point to point connection with his network operator.

It is known that networks are nowadays generally administered centrally. If an additional network element is added, then it is necessary to ensure that it “agrees” with the already existing network elements, that is to say that it has the correct interface to the network and has the correct drivers. The compatibility between the SIM card system and the terminal system should be considered. Usually, an application program could not apply in all kinds of mobile phones with different brands. One application program issued for some specific mobile phones should be re-modified, if the application program tends to be applied in other mobile phone of different specification. Obviously, an application program can't be common software applied for all mobile phones.

Therefore, it needs to provide a method of universalizing application program for use in the communication terminal, which introduce a standard Java Virtual machine for a combo-SIM system to providing a universalized mobile-platform, thereby increasing the currency of application programs used in the communication terminal, facilitating to develop application programs of low cost, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a method of universalizing application program for use in the communication terminal, which introduce a standard Java virtual machine for a combo card to providing a universalized mobile-platform, thereby increasing the currency of application programs used in the communication terminal, facilitating to develop application programs of low cost, and can rectify those drawbacks of the prior art and solve the above problems.

In accordance with an aspect of the present invention, a combo card for use with a communication terminal includes an integrated circuit unit for allowing communication between the communication terminal and an external base station; a memory module stored with a virtual machine for providing the communication terminal with a platform for various applications; and a controlling module for acting as an interface between the communication terminal and the integrated circuit unit to access the integrated circuit unit, and an interface between the communication terminal and the memory module to access the memory module.

Preferably, the communication terminal is one of a mobile phone and a personal digital assistant.

Preferably, the memory module is a flash memory.

Preferably, the flash memory is a NAND flash memory.

Preferably, the controlling module, the integrated circuit unit and the memory module are incorporated into a standard SIM card.

Preferably, the virtual machine is a Java virtual machine.

Preferably, the applications are executed via the virtual machine.

Certainly, the integrated circuit unit is a Subscriber Identity Module (SIM).

Certainly, the integrated circuit unit is a Universal Subscriber Identity Module (USIM).

Certainly, the integrated circuit unit is a User Identity Module (UIM).

Certainly, the integrated circuit unit is a Removable User Identity Module (RUIM).

In accordance with the aspect of the present invention, the method of providing a universal platform for an application program of communication terminals, includes the steps of: a) storing a virtual machine and an application program in a combo card; b) providing the combo card to each of the communication terminals; c) loading the virtual machine from the combo card; and d) executing the virtual machine to form the universal platform such that the application program can be performed in the communication terminals regardless of different operating systems of the communication terminals.

Preferably, the combo card further includes an integrated circuit unit for allowing communication between the communication terminal and an external base station, and a controlling module for acting as an interface between the communication terminal and the integrated circuit unit to access the integrated circuit unit.

Preferably, the integrated circuit unit is a Subscriber Identity Module (SIM).

Preferably, the integrated circuit unit is a Universal Subscriber Identity Module (USIM).

Preferably, the integrated circuit unit is a User Identity Module (UIM).

Preferably, the integrated circuit unit is a Removable User Identity Module (RUIM).

Certainly, the combo card further includes a memory module stored with a virtual machine (VM) for providing the communication terminal with a platform for various applications, and a controlling module for acting as an interface between the communication terminal and memory module to access the memory module.

Certainly, the virtual machine is a Java virtual machine.

Certainly, the communication terminals comprise a mobile phone and a personal digital assistant.

The above objects and advantages of the present invention will become more readily apparent to those ordinarily skilled in the art after reviewing the following detailed description and accompanying drawings, in which:

### BRIEF DESCRIPTION OF THE DRAWING

FIG. 1 illustrates an integrated circuit card for use with a communication terminal according to the present invention;

FIG. 2 illustrates a method of universalizing application programs for use in communication terminals according to the present invention; and

FIG. 3 illustrates a flow chart of a method of universalizing application programs for use in communication terminals according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

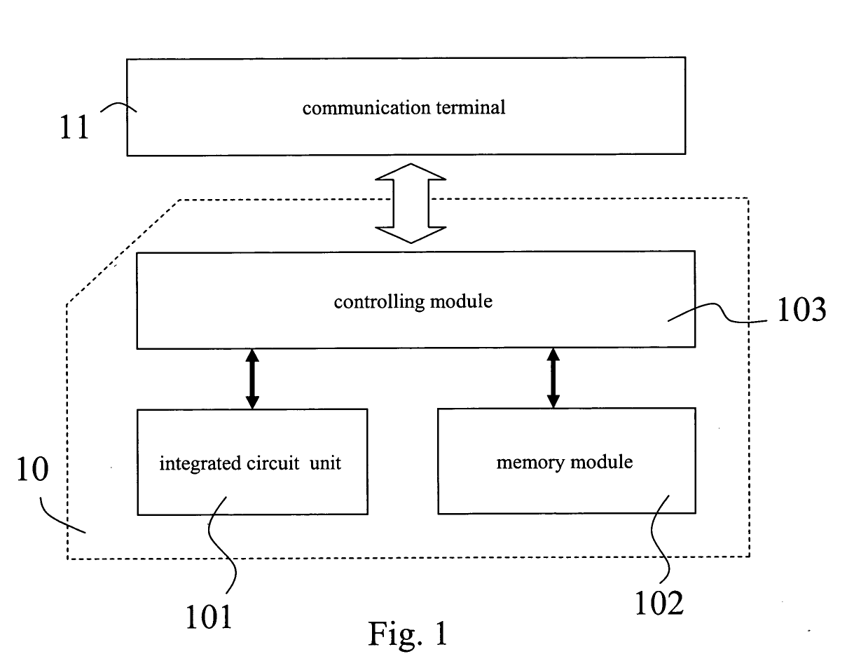

Please refer to FIG. 1. It illustrates a combo card shaped as a Standard SIM card for use with a communication terminal according to the present invention. The combo card 10 shaped as a Standard SIM card for use with a communication terminal 11, includes a SIM memory 101 for storing identification information of the communication terminal 11; an memory 102 for storing applications of the communication terminal 11; and a controlling module 103 contacted with the SIM memory 101 and the memory 102 for providing an interface to the communication terminal 11, wherein the controlling module 103 determines to access to the SIM memory 101 for the identification information, and to the memory 102 for the applications.

In practice, the communication terminal 11 can be one of a mobile phone and a personal digital assistant. In this embodiment, the communication 11 is a mobile phone. Moreover, the integrated SIM system 10 is shaped as a Standard SIM card, and could be able to insert into a standard SIM card holder (not shown) of the communication terminal 11. Being different from the original SIM card of the prior art, the integrated SIM system further introduces the memory 102 for providing an interface to the communication terminal 11, wherein the memory 102 can be a NAND flash memory. Obviously, the integrated SIM system 10 provides more memory space for user, wherein the memory 102 could store a lot of application programs. On the other hand, the present invention further introduces the controlling module 103 as the interface connected with the communication terminal, wherein a universalized mobile-platform is formed by means of combining the memory 102 and the controlling module 103. Therefore, the present invention will be able to introduce new services quickly and to have more services unique to the network. Furthermore, in the embodiment, the present invention could introduce a standard Java Virtual machine (VM) into the combo-SIM system (stored in the memory 102 and accessed via the controlling module 103) to providing a universalized mobile-platform, thereby increasing the currency of application programs used in the communication terminal and facilitating to develop application programs.

In conclusion, the present invention provides an integrated SIM-card system for use in the communication terminal, which integrates a controlling IC module and a NAND flash module with the original SIM card for providing the application programs with more memory space and facilitating to extend the services from the original SIM card. Furthermore, the present invention could introduce a standard Java Virtual machine (VM) into the combo-SIM system to providing a universalized mobile-platform, thereby increasing the currency of application programs used in the communication terminal and facilitating to develop application programs, but the prior art fail to disclose that.

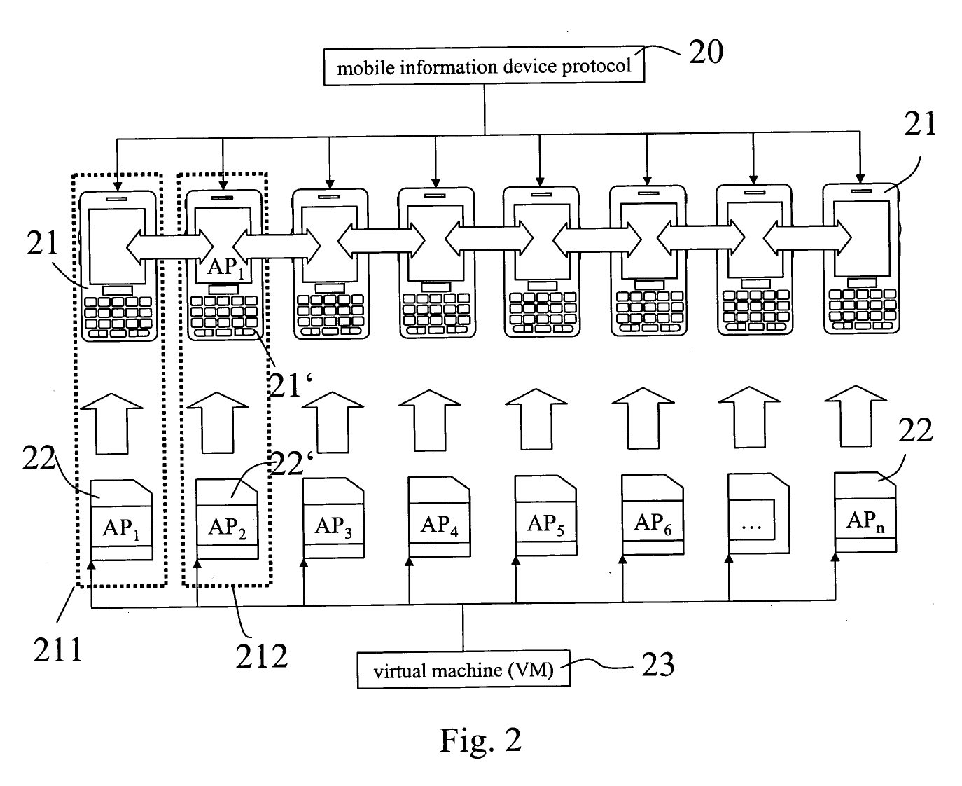

Please refer to FIG. 2. It illustrates a method of universalizing application programs for use in communication terminals according to the present invention. As shown in FIG. 2, the method of universalizing application programs for use in communication terminals 21, includes the steps of a) providing a mobile information device protocol 20 to introduce into the communication terminals 21; b) providing a combo card 22 having a virtual machine 23 and an application program AP₁˜APₙ in accordance with the mobile information device protocol 20 for introducing to the communication terminal 21 and forming a universalized mobile-platform; c) connecting the combo card 22 with the communication terminal 21 by means of inserting the combo card 22 into the SIM card holder (not shown) of the communication terminal 21; and d) loading the application program AP₁˜APₙ from the combo card 22 and executing via the virtual machine 23, thereby the application program being performed in the communication terminal 21.

In practice, the step a) and the step b) are executed by manufacturers and, the step c) is executed by means of inserting the combo card 22 into a standard SIM card holder of the communication terminal 21 via users. The combo card 22 further includes a memory (not shown) for storing the virtual machine 23 and the application programs AP₁˜APₙ. Due to providing a universalized mobile-platform, the method of the present invention further includes step e) transmitting an additional application program AP₁ form a first combo card 22 combined with a first communication terminal 21 (set 211) to a second combo card 22′ combined with a second communication terminal 21′ (set 212), wherein the additional application AP₁ is stored in the first combo card 22, the first combo card 22 and the second combo card 22′ have the virtual machine 23, and the first communication terminal 21 and the second communication terminal 21 have the mobile information device protocol 20. Accordingly, the method of universalizing application programs further includes step f) executing the additional application program AP₁ via the second combo card 22′ of the second communication terminal 21′. After loading and executing the additional application program AP₁, the additional application program AP₁ could be stored in the second combo card 22′. Therefore, the method of universalizing application programs further includes step g) storing the additional application program AP₁ in the second combo card 22′ of the second communication terminal 21′. In this present invention, the virtual machine can be a Java virtual machine. The communication terminal 21 is one of a mobile phone and a personal digital assistant. Certainly, the combo card 22 can be further combined with a standard SIM card for the communication terminal 21.

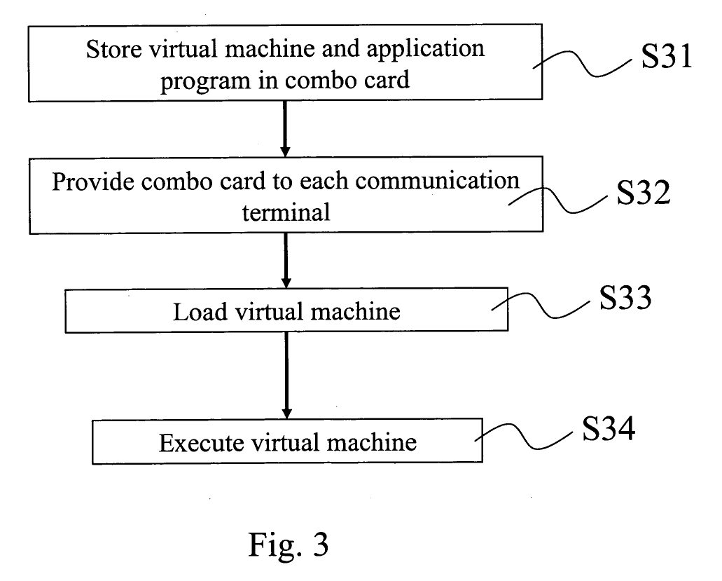

Please refer to FIG. 3. It illustrates a flow chart of a method of universalizing application programs for use in communication terminals according to the present invention. As shown in FIG. 3, the method of providing a universal platform for an application program of communication terminals, includes the steps of: a) storing a virtual machine (VM) and an application program in a combo card via the manufacturer, as shown in step S31, wherein the application program could be executed by the virtual machine; b) providing the combo card to each of the communication terminals, as shown in step S32, wherein the communication terminals access to the combo card; c) loading the virtual machine from the combo card, as shown in step S33; and d) executing the virtual machine to form the universal platform, as shown in step S34, such that the application program can be performed in the communication terminals regardless of different operating systems of the communication terminals. Furthermore, refer to FIG. 2, the application program AP₁ can be transmitted from one communication terminal 21 with the combo card 22 to another communication terminal 21′ with the combo card 22′ via the universal platform.

In practice, the manufacturer provides communication terminals with the mobile information device protocol, and provides combo cards with the virtual machine and the application program, thereby forming the universalized mobile-platform to extend the service of additional application programs. When a user buy a communication terminal with the mobile information device protocol and a combo card with the virtual machine and the application program, a lot of application programs in accordance with the virtual machine could be executed on the user's communication terminal after inserting the combo card into a standard SIM card holder of the communication terminals. Without change the original communication terminal, the combo card could be combined with a standard SIM card. Furthermore, the virtual machine is a Java virtual machine; and the combo card further includes a memory for storing the virtual machine, the plural application programs and the additional application programs. Accordingly, the present invention provides a method of universalizing application program by means of introducing a universalized mobile-platform of virtual machine in accordance with the mobile information device protocol, thereby the currency of application programs being available.

In conclusion, the present invention provides a method of universalizing application program for use in the communication terminal, which introduce a standard Java virtual machine for a combo-SIM system to providing a universalized mobile-platform, thereby increasing the currency of application programs used in the communication terminal, facilitating to develop application programs of low cost, but the prior art fail to disclose that. Accordingly, the present invention possesses many outstanding characteristics, effectively improves upon the drawbacks associated with the prior art in practice and application, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method of providing a universal platform for an application program of communication terminals, comprising the steps of:
a) storing a virtual machine and an application program in a combo card;
b) providing said combo card to each of said communication terminals;
c) loading said virtual machine from said combo card; and
d) executing said virtual machine to form said universal platform such that said application program can be performed in said communication terminals regardless of different operating systems of said communication terminals.

2. The method according to claim 1, wherein said combo card further comprises an integrated circuit unit for allowing communication between said communication terminal and an external base station, and a controlling module for acting as an interface between said communication terminal and said integrated circuit unit to access said integrated circuit unit.

3. The method according to claim 2, wherein said integrated circuit unit is a Subscriber Identity Module (SIM).

4. The method according to claim 2, wherein said integrated circuit unit is a Universal Subscriber Identity Module (USIM).

5. The method according to claim 2, wherein said integrated circuit unit is a User Identity Module (UIM).

6. The method according to claim 2, wherein said integrated circuit unit is a Removable User Identity Module (RUM).

7. The method according to claim 1, wherein said combo card further comprises a memory module stored with a virtual machine (VM) for providing said communication terminal with a platform for various applications, and a controlling module for acting as an interface between said communication terminal and memory module to access said memory module.

8. The method according to claim 1, wherein said virtual machine is a Java virtual machine.

9. The method according to claim 1, wherein said communication terminals comprise a mobile phone and a personal digital assistant.

10. A combo card for use with a communication terminal, comprising:
an integrated circuit unit for allowing communication between said communication terminal and an external base station;
a memory module stored with a virtual machine for providing said communication terminal with a platform for various applications; and
a controlling module for acting as an interface between said communication terminal and said integrated circuit unit to access said integrated circuit unit, and an interface between said communication terminal and said memory module to access said memory module.

11. The combo card according to claim 10, wherein said communication terminal is one of a mobile phone and a personal digital assistant.

12. The combo card according to claim 10, wherein said memory module is a flash memory.

13. The combo card according to claim 12, wherein said flash memory is a NAND flash memory.

14. The combo card according to claim 10, wherein said controlling module, said integrated circuit unit and said memory module are incorporated into a standard SIM card.

15. The combo card according to claim 10, wherein said virtual machine is a Java virtual machine.

16. The combo card according to claim 10, wherein said applications are executed via said virtual machine.

17. The combo card according to claim 10, wherein said integrated circuit unit is a Subscriber Identity Module (SIM).

18. The combo card according to claim 10, wherein said integrated circuit unit is a Universal Subscriber Identity Module (USIM).

19. The combo card according to claim 10, wherein said integrated circuit unit is a User Identity Module (UIM).

20. The combo card according to claim 10, wherein said integrated circuit unit is a Removable User Identity Module (RUIM).
